(19) United States
(12) Patent Application Publication
(10) Pub. No.: US 2012/0127416 A1
(43) Pub. Date: May 24, 2012

(54) LIQUID CRYSTAL DISPLAY DEVICE

(75) Inventors: Katsuhiko Morishita, Osaka (JP); Tsuyoshi Okazaki, Osaka (JP); Takehiko Sakai, Osaka (JP); Dai Chiba, Osaka (JP); Shingo Kawashima, Osaka (JP); Tetsuo Fujita, Osaka (JP); Miyuki Yonezawa, Osaka (JP)

(73) Assignee: Sharp Kabushiki Kaisha, Osaka (JP)

(21) Appl. No.: 13/382,042

(22) PCT Filed: May 10, 2010
(86) PCT No.: PCT/JP2010/057866

§ 371 Date: Feb. 1, 2012

(30) Foreign Application Priority Data
Jul. 3, 2009 (JP) 2009-158673
Jan. 15, 2010 (JP) 2010-006695

(51) Int. Cl. G02F 1/1343

(52) U.S. Cl. 349/141

(57) ABSTRACT

The present invention provides a liquid crystal display device having improved transmittance. The liquid crystal display device according to the present invention has a first substrate and a second substrate disposed to face each other, and a liquid crystal layer interposed between the first substrate and the second substrate. The first substrate includes a pixel electrode to which a signal voltage is supplied and a common electrode to which a common voltage is supplied. The pixel electrode and the common electrode both comprise comb teeth. The comb teeth of the pixel electrode and the comb teeth of the common electrode are disposed with each other alternately via an interval. The liquid crystal layer contains liquid crystal molecules having positive dielectric anisotropy. The liquid crystal molecules are aligned in a direction orthogonal to a surface of the first substrate in a voltage non-application condition. The first substrate includes an extension wiring provided in a position overlapping at least one comb tooth of the comb teeth of the pixel electrode and the common electrode so as to extend along the at least one comb tooth via an insulating film, and the extension wiring serves as a wiring to which the signal voltage is supplied.

### TECHNICAL FIELD

The present invention relates to a liquid crystal display device, and more particularly to a liquid crystal display device that can be used favorably in a TBA mode.

### BACKGROUND ART

Features of a liquid crystal display device include a thin profile, a light weight, and low power consumption, and therefore liquid crystal display devices are used widely in various fields. Furthermore, dramatic progress has been made over the years in a display capability of a liquid crystal display device such that the display capability now surpasses that of a CRT (Cathode Ray Tube) display.

A display method of a liquid crystal display device is determined by an alignment of liquid crystal within a cell. Known examples of display methods used conventionally in liquid crystal display devices include a TN (Twisted Nematic) mode, an MVA (Multi-domain Vertical Alignment) mode, an IPS (In-Plane Switching) mode, and an OCB (Optically self-Compensated Birefringence) mode.

Liquid crystal display devices using these display methods are mass-produced. Of these devices, TN mode liquid crystal display devices are in wide general use. However, there is room for improvement in a TN mode liquid crystal display device in terms of a response time, a viewing angle, and so on.

In the MVA mode, on the other hand, a slit is provided in a pixel electrode of an active matrix substrate, a projection (a rib) for controlling the alignment of liquid crystal molecules is provided on a common electrode of an opposed substrate, and a fringe field formed thereby is used to disperse an alignment direction of the liquid crystal molecules in a plurality of directions. Furthermore, in the MVA mode, a wide viewing angle is realized by dividing a liquid crystal layer into a plurality of regions (multi-domain) for each direction in which the liquid crystal molecules fall when a voltage is applied thereto. Moreover, the MVA mode is a vertical alignment mode, and therefore a high contrast is obtained in comparison with the TN, IPS, and OCB modes. However, a manufacturing process is complicated, and similarly to the TN mode, there is room for improvement in terms of the response time.

A liquid crystal display device including a liquid crystal substance layer having a first substrate and a second substrate that oppose each other and liquid crystal molecules injected between the first and second substrates so as to be aligned vertically relative to the first substrate and the second substrate, and at least two electrodes provided parallel to each other and formed on one of the first substrate and the second substrate, for example, has been proposed in response to these processing problems occurring in the MVA mode (see Patent Document 1, for example). With this method, alignment control using a projection is not required, and therefore a picture element configuration is simplified such that a superior viewing angle characteristic is obtained.

Patent Document 1: Japanese Patent Application Publication No. H10-333171

### DISCLOSURE OF THE INVENTION

The present inventors have conducted research into a display method (to be referred to in this specification as a TBA (Transverse Bend Alignment) mode) in which p (positive) type nematic liquid crystal is used as a liquid crystal material and an arch-shaped transverse electric field is generated using a pair of comb tooth-shaped electrodes provided on a single substrate while maintaining the high contrast characteristic obtained with a vertical alignment. With this method, an alignment bearing of the liquid crystal molecules positioned between the pair of comb tooth-shaped electrodes is defined as a shape close to a bend alignment in a transverse direction. Developments leading to the present invention will be described below using the TBA mode as an example. However, the present invention is not limited to the TBA mode.

FIG. 13 is a sectional schematic view showing an ideal alignment condition of liquid crystal molecules when a voltage is applied to a liquid crystal layer provided in a TBA mode liquid crystal display device. As shown in FIG. 13, a liquid crystal display panel 1 provided in the TBA mode liquid crystal display device includes a liquid crystal layer 4 and a pair of substrates constituted by a first substrate 2 and a second substrate 3, between which the liquid crystal layer 4 is interposed. When a voltage is applied to the liquid crystal layer 4, an alignment bearing of liquid crystal molecules positioned between a pair of comb tooth-shaped electrodes 21, 22 constituted by a pixel electrode 21 and a common electrode 22 forms an arch shape close to a bend alignment in a transverse direction, whereas in positions overlapping the pair of comb-tooth shaped electrodes 21, 22, a vertical alignment is maintained (this alignment will also be referred to as a “TBA alignment” hereafter).

More specifically, an initial alignment condition (an alignment condition when no voltage is applied) of the liquid crystal molecules of the nematic liquid crystal material used in the liquid crystal layer 4 in the TBA mode is a vertical alignment, and therefore light is transmitted as is without applying a phase difference. When a voltage is applied to the comb-tooth shaped pixel electrode 21 and common electrode 22 such that a transverse electric field is generated in the liquid crystal layer 4, as shown in FIG. 13, on the other hand, two domains having director directions that differ from each other by 180° are formed between the pair of comb-tooth shaped electrodes 21, 22, and the TBA-aligned liquid crystal molecules in each domain apply a phase difference to the light transmitted through the liquid crystal molecules so that the light can be used as display light. Note that FIG. 13 shows the alignment condition of the liquid crystal molecules in a case where a width of respective comb teeth of the pixel electrode 21 and the common electrode 22 is set at 4 μm, an interval between the comb teeth is set at 4 μm, a liquid crystal layer thickness is set at 4 μm, and a 7 V voltage is applied to the liquid crystal layer 4.

Further, according to this alignment method, a similar display quality to that obtained when a display surface is viewed from a head-on direction can be obtained when the display surface is viewed from a diagonal direction, and therefore a problem such as that occurring in the VA mode, for example, where the liquid crystal molecules take a rod shape such that a birefringent condition of the light differs between the head-on direction and the diagonal direction, leading to variation in a voltage-transmission characteristic (a V-T characteristic) depending on the viewing angle, is eliminated.

According to investigations conducted by the present inventors, however, it may be impossible, depending on design conditions, to obtain the TBA alignment in p-type nematic liquid crystal even when p-type nematic liquid crystal is used as the liquid crystal material, the p-type nematic liquid crystal is aligned vertically in the initial alignment, and a transverse electric field is generated in the liquid crystal layer using a pair of comb tooth-shaped electrodes.

FIGS. 14 and 15 are sectional schematic views showing a liquid crystal display device (Reference Example 1) in a condition where the TBA alignment is not obtained even when a transverse electric field is generated using a pair of comb-tooth shaped electrodes in relation to a liquid crystal layer containing vertically aligned p-type nematic liquid crystal. FIG. 14 is a schematic view showing equipotential lines and a transmitted light intensity in addition to a device configuration, and FIG. 15 is a schematic view additionally showing the alignment condition of the liquid crystal molecules.

As shown in FIGS. 14 and 15, the liquid crystal display device according to Reference Example 1 includes a TFT substrate 2 and an opposed substrate 3, which oppose each other via the liquid crystal layer 4. The TFT substrate 2 includes, in order toward the liquid crystal layer 4 side, an insulating substrate 31, an interlayer dielectric 33 having a stacked structure that includes an inorganic insulating film 33a and an organic insulating film 33b, a pixel electrode 21, and a common electrode 22. The opposed substrate 3 includes, in order toward the liquid crystal layer 4 side, an insulating substrate 41 and an overcoat layer 43.

An electric field that depicts an arch shape is generated in the liquid crystal layer 4 of the liquid crystal display device according to Reference Example 1 roughly between the pair of electrodes constituted by the pixel electrode 21 and the common electrode 22. However, a region having tightly packed equipotential lines is formed in a central location of the liquid crystal layer between the pair of electrodes 21, 22 and the vicinity thereof, and since the electric field is strong in the region having tightly packed equipotential lines, the equipotential lines are formed in an opposite direction to an orientation of the arch-shaped electric field. The p-type nematic liquid crystal has a property whereby it attempts to align horizontally relative to the orientation of the electric field, but some of the liquid crystal molecules positioned in the region having tightly packed equipotential lines are aligned in a direction that does not correspond to the arch shape. Hence, in the center of the liquid crystal layer 4 between the pair of electrodes 21, 22 and the vicinity thereof, a reduction in transmittance occurs in comparison with other regions.

The present invention has been designed in consideration of the current circumstances described above, and an object thereof is to provide a liquid crystal display device having improved transmittance.

Having undertaken various investigations into means for improving the transmittance in the liquid crystal display device according to Reference Example 1, the present inventors focused on the reduction in transmittance occurring in the region of the liquid crystal layer having tightly packed equipotential lines (the region where the equipotential lines are concentrated in FIGS. 14 and 15). The present inventors discovered that by providing a conductive member having a certain potential in a position overlapping the comb teeth of one of a pair of comb tooth-shaped electrodes via an insulating film in order to define a TBA alignment in a wider range by reducing a range of the region having tightly packed equipotential lines, which is positioned in a central location between the pair of comb tooth-shaped electrodes and the vicinity thereof, the position of the region having tightly packed equipotential lines shifts and the range thereof narrows. Further, the present inventors discovered that by using a wiring to which a signal voltage is supplied as the aforesaid conductive member, the transmittance can be improved effectively. Thus, the present inventors solved the problems described above with great success, thereby arriving at the present invention.

More specifically, the present invention is a liquid crystal display device having a first substrate and a second substrate disposed to face each other, and a liquid crystal layer interposed between the first substrate and the second substrate, wherein: the first substrate includes a pixel electrode to which a signal voltage is supplied and a common electrode to which a common voltage is supplied; the pixel electrode and the common electrode both have comb teeth; the comb teeth of the pixel electrode and the comb teeth of the common electrode are disposed with each other alternately via an interval; the liquid crystal layer contains liquid crystal molecules having positive dielectric anisotropy; the liquid crystal molecules are aligned in a direction orthogonal to a surface of the first substrate in a voltage non-application condition; the first substrate includes an extension wiring provided in a position overlapping at least one comb tooth of the comb teeth of the pixel electrode and the common electrode so as to extend along the at least one comb tooth via an insulating film; and the extension wiring serves as a wiring to which the signal voltage is supplied.

The liquid crystal display device according to the present invention includes the first substrate and the second substrate disposed to face each other and the liquid crystal layer interposed between the first substrate and the second substrate. Liquid crystal molecules subjected to alignment control by applying a certain voltage thereto are charged into the liquid crystal layer. By providing a wiring, an electrode, a semiconductor element, and the like on the first substrate and/or the second substrate, a voltage can be applied to the liquid crystal layer, and as a result, the alignment of the liquid crystal molecules can be controlled.

The first substrate includes the pixel electrode to which the signal voltage is supplied and the common electrode to which the common voltage is supplied. The pixel electrode and the common electrode both have comb teeth. The comb teeth of the pixel electrode and the comb teeth of the common electrode are disposed with each other alternately via an interval. In this specification, a “comb tooth” is a site formed to project in planar form from a site serving as a trunk portion when the first substrate is viewed from a normal direction. An electric field generated when a potential difference is applied between a pair of electrodes having such comb teeth is an arch-shaped transverse electric field, for example. The liquid crystal molecules exhibit an alignment corresponding to an orientation of the electric field, and therefore a similar display is exhibited in both a head-on direction and a diagonal direction relative to a substrate surface. As a result, a superior viewing angle characteristic is obtained.

The liquid crystal layer contains liquid crystal molecules having positive dielectric anisotropy. Therefore, when a voltage is applied to the liquid crystal layer, the liquid crystal molecules are aligned in accordance with the orientation of the electric field, and as a result, the liquid crystal molecules depict an arch shape, for example.

The liquid crystal molecules are aligned in a direction orthogonal to the surface of the first substrate in the voltage non-application condition. By adjusting an initial alignment of the liquid crystal molecules in this manner, light can be blocked effectively during black display. In an example of a method for vertically aligning the liquid crystal molecules in the voltage non-application condition, a vertical alignment film is disposed on a surface of the first substrate and/or the second substrate that contacts the liquid crystal layer.

Hence, in the liquid crystal display device according to the present invention, the liquid crystal molecules are vertically aligned in the voltage non-application condition, and therefore a high contrast can be obtained. Further, a TBA alignment can be exhibited in a voltage application condition, and as a result, a superior viewing angle characteristic can be obtained.

The first substrate includes the extension wiring provided in a position overlapping at least one comb tooth of the comb teeth of the pixel electrode and the common electrode so as to extend along the at least one comb tooth via an insulating film, and the extension wiring serves as a wiring to which the signal voltage is supplied. By disposing an extension wiring having a certain potential in a position overlapping at least one comb tooth of the comb teeth of the pixel electrode and the common electrode, a range of a region having tightly packed equipotential lines, which is formed between the pixel electrode and the common electrode, can be reduced such that a desired alignment can be obtained. For example, a sufficient TBA alignment can be obtained. Further, the extension wiring is a wiring to which the signal voltage is supplied, and therefore an effective configuration is realized.

The extension wiring is preferably disposed along all of the comb teeth of the pixel electrode in pixel region units or along all of the comb teeth of the common electrode in pixel region units. In so doing, a transmittance improvement effect can be obtained over a wider range.

The configuration of the liquid crystal display device of the present invention is not especially limited by other components as long as it essentially includes such components.

Preferable embodiments of the liquid crystal display device of the present invention are mentioned in more detail below.

The pixel electrode is preferably connected to a drain electrode of a thin film transistor via a contact portion and the extension wiring. The liquid crystal display device according to the present invention includes a thin film transistor (TFT), and therefore control can be performed by the TFT to switch the signal voltage applied to the pixel electrode ON and OFF. Further, by employing the contact portion and the extension wiring as means for connecting the pixel electrode to the TFT, an improvement in design freedom and an increase in an aperture ratio, for example, can be obtained. By employing this type of extension wiring, the range of the region having tightly packed equipotential lines can be reduced, and therefore an effective configuration is realized.

The extension wiring preferably overlaps the comb teeth of the common electrode via an insulating film. The extension wiring has a potential of the signal voltage, and therefore, by causing the extension wiring to overlap the common electrode having a common potential via an insulating film, disturbance can be generated in the electric field formed between the pixel electrode having a signal potential and the common electrode. As a result, the range of the region having tightly packed equipotential lines can be reduced.

The extension wiring preferably overlaps the comb teeth of the pixel electrode via an insulating film. The extension wiring has the potential of the signal voltage, and therefore, by causing the extension wiring to overlap the pixel electrode having the signal potential via an insulating film, disturbance can be generated in the electric field formed between the pixel electrode and the common electrode having the common potential. As a result, the range of the region having tightly packed equipotential lines can be reduced.

The extension wiring preferably includes a trunk portion and a plurality of comb teeth extending from the trunk portion. By providing the extension wiring with the trunk portion and the plurality of comb teeth in accordance with the shape of the pixel electrode, the extension wiring can be caused to overlap the comb teeth of the pixel electrode or the comb teeth of the common electrode effectively. Further, the trunk portion can be caused to overlap a storage capacitance wiring and used thus as means for securing electrostatic capacitance. As a result, an effective configuration is realized.

The pixel electrode preferably includes a trunk portion and a plurality of comb teeth extending from the trunk portion. By providing the pixel electrode with the trunk portion and the plurality of comb teeth, the comb teeth of the pixel electrode can easily be formed in a symmetrical shape. When the comb teeth are symmetrical to each other, the viewing angle characteristic can be improved.

The common electrode is preferably disposed on a periphery of the pixel electrode. By disposing the common electrode on the periphery of the pixel electrode, an electric field can easily be formed between the common electrode and the pixel electrode. Further, when the common electrode includes a trunk portion and comb teeth, for example, the trunk portion can be disposed in a light blocking region such that only the comb teeth are disposed in a picture element region. As a result, the picture element region can be widened, leading to an improvement in the aperture ratio.

A width of the extension wiring is preferably smaller than a width of the at least one comb tooth overlapped by the extension wiring. In the TBA alignment, the liquid crystal molecules that overlap the comb tooth of the pixel electrode or the comb tooth of the common electrode in the liquid crystal layer when the first substrate is seen from the normal direction remain vertically aligned even when a voltage is applied, and cannot therefore contribute to display. Of these liquid crystal molecules, however, liquid crystal molecules overlapping either side of the comb tooth are slightly more tilted than liquid crystal molecules overlapping the center of the comb tooth, and therefore these liquid crystal molecules can be used for display. Hence, by making the width of the extension wiring narrower than the width of the comb tooth, a further improvement in transmittance can be achieved.

### EFFECT OF THE INVENTION

According to the present invention, an improvement in transmittance can be achieved in a liquid crystal display device of a type that employs a pair of comb tooth-shaped electrodes in a liquid crystal layer containing vertically aligned p-type nematic liquid crystal.

### BRIEF DESCRIPTION OF THE DRAWINGS

FIG. 1 is an enlarged planar schematic view showing a display region of a liquid crystal display device according to a first embodiment.

FIG. 2 is a sectional schematic view showing an electric field generated in a liquid crystal layer of the liquid crystal display device according to the first embodiment, and a schematic view showing equipotential lines and a transmitted light intensity in addition to a device configuration.

FIG. 3 is a sectional schematic view showing the electric field generated in the liquid crystal layer of the liquid crystal display device according to the first embodiment, and a schematic view additionally showing an alignment condition of liquid crystal molecules.

FIG. 4 is a sectional schematic view showing the liquid crystal display device according to the first embodiment, taken along an A-B line in FIG. 1.

FIG. 5 is a sectional schematic view showing the liquid crystal display device according to the first embodiment, taken along a C-D line in FIG. 1.

FIG. 6 is an enlarged planar schematic view showing a display region of a liquid crystal display device according to a second embodiment.

FIG. 7 is an enlarged planar schematic view showing a display region of a liquid crystal display device according to a third embodiment.

FIG. 8 is an enlarged planar schematic view showing a display region of a liquid crystal display device according to a fourth embodiment.

FIG. 9 is a sectional schematic view taken along an E-F line in FIG. 8.

FIG. 10 is a sectional schematic view showing an electric field formed in a liquid crystal layer of the liquid crystal display device according to the fourth embodiment, and a schematic view showing equipotential lines and a transmitted light intensity in addition to a device configuration.

FIG. 11 is a sectional schematic view showing the electric field formed in the liquid crystal layer of the liquid crystal display device according to the fourth embodiment, and a schematic view additionally showing an alignment condition of liquid crystal molecules.

FIG. 12 is an enlarged planar schematic view showing a display region of a liquid crystal display device according to a third modified example of the fourth embodiment.

FIG. 13 is a sectional schematic view showing an ideal alignment condition of liquid crystal molecules when a voltage is applied to a liquid crystal layer provided in a TBA mode liquid crystal display device.

FIG. 14 is a sectional schematic view showing a liquid crystal display device according to Reference Example 1, and a schematic view showing equipotential lines and a transmitted light intensity in addition to a device configuration.

FIG. 15 is a sectional schematic view showing the liquid crystal display device according to Reference Example 1, and a schematic view additionally showing an alignment condition of liquid crystal molecules.

FIG. 16 is a sectional schematic view showing a configuration of a liquid crystal display device according to a fifth embodiment.

### MODES FOR CARRYING OUT THE INVENTION

The present invention will be mentioned in more detail referring to the drawings in the following embodiments, but is not limited to these embodiments.

### First Embodiment

A liquid crystal display device according to a first embodiment is a TBA mode liquid crystal display device in which image display is controlled by generating an arch-shaped transverse electric field in a liquid crystal layer using a pair of electrodes formed on a single substrate and controlling an alignment of liquid crystal molecules that are aligned vertically in an initial alignment.

In the liquid crystal display device according to the first embodiment, a plurality of picture elements, each constituted by a plurality of pixels (sub-pixels), are formed in a matrix shape. FIG. 1 is an enlarged planar schematic view showing a display region of the liquid crystal display device according to the first embodiment.

As shown in FIG. 1, the liquid crystal display device according to the first embodiment includes a source bus line 11 for transmitting an image signal, a gate bus line 12 for transmitting a scanning signal, a Cs bus line 13 that forms storage capacitance, and a TFT 14 provided as a switching element for each pixel. The TFT 14 is provided in the vicinity of an intersecting portion between the source bus line 11 and the gate bus line 12, and includes a source electrode connected to the source bus line 11, a gate electrode connected to the gate bus line 12, and a drain electrode connected to the source electrode via a semiconductor layer.

The source bus line 11 is connected to a source driver such that a source voltage (a signal voltage) serving as an image signal supplied from the source driver is applied to the TFT 14. Further, the gate bus line 12 is connected to a gate driver such that a gate voltage serving as a scanning signal supplied in pulse form at a predetermined timing from the gate driver is applied to the TFT 14 in line sequence. A magnitude of the signal voltage is preferably set between 20 and 30 V.

The respective gate bus lines 12 are provided to extend rectilinearly and parallel to each other. The respective Cs bus lines 13 extend rectilinearly and parallel to each other. Further, the gate bus line 12 and the Cs bus line 13 are disposed alternately so as to extend parallel to each other. The respective source bus lines 11 extend parallel to each other in a vertical direction, but are formed in a sideways V shape rather than a rectilinear shape. Therefore, when seen as a whole, the source bus lines 11 take a zigzag shape.

A pixel region is defined as a region in which the liquid crystal molecules are controlled by controlling a voltage applied to a pixel electrode 21 using a single TFT 14, or in other words a region surrounded by the source bus line 11 and the gate bus line 12. Hence, the pixel region also takes a sideways V shape, or in other words an arrow tip shape. In the first embodiment, the Cs bus line 13 extends so as to traverse a center of each pixel region.

An extension wiring (also referred to hereafter as a drain lead-out wiring) 16 is led out from the drain electrode of the TFT 14, and the TFT 14 is connected to the pixel electrode 21 via the drain lead-out wiring 16 and a contact portion 17. In other words, in the first embodiment, the drain lead-out wiring 16 constitutes an extension wiring of the present invention. Hence, when the TFT 20 is switched ON for a certain time period following input of the scanning signal, the signal voltage supplied from the source bus line 11 is applied to the pixel electrode 21 at a predetermined timing.

The pixel electrode 21 includes a trunk portion 21a having a large surface area and disposed in the vicinity of a region connected to the contact portion 17, and a plurality of comb teeth 21b extending from the trunk portion 21a. The comb teeth 21b of the pixel electrode 21 are formed in a plurality within a single pixel region such that the pixel electrode 21 has a vertically symmetrical pattern about a bisector dividing the longitudinal sides of the pixel region as an axis of symmetry. More specifically, the pixel electrode 21 has a vertically symmetrical pattern about a bisector extending vertically to the extension direction of the entire source bus line 11 when the source bus line 11 is taken as a reference, about a center line between the gate bus lines 12 when the gate bus line 12 is taken as a reference, and about a straight line extending along the Cs bus line 13 when the Cs bus line 13 is taken as a reference.

The comb teeth 21b of the pixel electrode 21 are all provided to extend parallel to the source bus line 11. Therefore, of the respective comb teeth 21b, the comb teeth 21b in one of the regions divided by the bisector vertically to the longitudinal direction extend toward one side and parallel to each other via a certain interval, and the comb teeth 21b in the other region divided by the bisector vertically to the longitudinal direction extend toward the other side and parallel to each other via a certain interval. Hence, when seen as a whole, the pixel electrode 21 likewise takes a sideways V shape, or a shape in which a plurality of sideways V shapes are arranged in series. In other words, the pixel electrode 21 takes an arrow tip shape.

The liquid crystal display device according to the first embodiment includes, in addition to the pixel electrode 21, a common electrode 22 to which a common voltage is applied. The common electrode 22 includes a trunk portion 22a formed on each of the source bus line 11 and the gate bus line 12 via an insulating film, and a plurality of comb teeth 22b extending from the trunk portion 22a toward the interior of the pixel region, and is disposed on a periphery of the pixel electrode 21. A magnitude of the common voltage is preferably set between 6 and 7 V.

The comb teeth 22b of the common electrode 22 are formed in gaps between the comb teeth 21b of the pixel electrode 21. Therefore, the comb teeth 21b of the pixel electrode 21 and the comb teeth 22b of the common electrode 22 have a mutually parallel relationship. Furthermore, similarly to the pixel electrode 21, the common electrode 22 has a vertically symmetrical pattern about a bisector dividing the longitudinal sides of the pixel region as the axis of symmetry.

Hence, the comb teeth 21b of the pixel electrode 21 and the comb teeth of the common electrode 22b are disposed so as to face each other in parallel in an identical plane and so as to be disposed with each other alternately via a certain interval. By generating a transverse electric field between the comb teeth of the pixel electrode 21 and the comb teeth of the common electrode 22, the alignment of the liquid crystal molecules in the liquid crystal layer can be controlled.

To achieve an increase in transmittance, a width of the comb teeth 21b of the pixel electrode 21 and a width of the comb teeth 22b of the common electrode 22 are both preferably as narrow as possible. Under current processing rules, the respective widths are preferably set between 1 and 4 μm, and more preferably between 2.5 and 4.0 μm. Further, a width of comb teeth 16b of the drain lead-out wiring 16 is preferably between 1 and 4 μm. Note that the width of the comb teeth 16b of the drain lead-out wiring 16 is formed to be smaller than the width of the comb teeth 22b of the common electrode 22, preferably. In so doing, an improvement in transmittance can be achieved.

The size of the interval between the comb teeth 21b of the pixel electrode 21 and the comb teeth 22b of the common electrode 22 is not especially limited, but is preferably between 2.5 and 20.0 μm and more preferably between 4.0 and 12.0 μm. When the interval is larger than 20.0 μm or smaller than 2.5 μm, the transmittance may decrease.

In FIG. 1, the source bus line 11 and the gate bus line 12 are shown to form an angle of 45°, but the angle formed by the source bus line 11 and the gate bus line 12 in the first embodiment is not limited thereto, and may be set within an angle range of 30 to 60°. Note, however, that to obtain a favorably balanced viewing angle characteristic, the angle formed by the source bus line 11 and the gate bus line 12 is preferably 45°.

The drain lead-out wiring 16 likewise includes a trunk portion 16a having a large surface area and disposed in the vicinity of a region connected to the contact portion 17, and a plurality of comb teeth 16b extending from the trunk portion 16a. The drain lead-out wiring 16 is connected to the pixel electrode 21 via the contact portion 17, and forms storage capacitance relative to the Cs bus line 13. More specifically, in the first embodiment, the drain lead-out wiring 16 includes the trunk portion 16a and comb teeth 16b, 16c extending from either side of the trunk portion 16a. The trunk portion 16a of the drain lead-out wiring 16 is connected to the pixel electrode 21 via the contact portion 17, which is provided on an insulating film, and disposed to overlap the Cs bus line 13 via an insulating film, thereby forming a certain amount of storage capacitance.

Hence, the drain lead-out wiring 16 is configured to include the trunk portion 16a and the comb teeth 16b, and the comb teeth 16b of the drain lead-out wiring 16 are formed in gaps between the comb teeth 21b of the pixel electrode 21. Accordingly, the comb teeth 21b of the pixel electrode 21 and the comb teeth 16b of the drain lead-out wiring 16 have a mutually parallel relationship. Further, similarly to the pixel electrode 21 and the common electrode 22, the drain lead-out wiring 16 has a vertically symmetrical pattern about a bisector dividing the longitudinal sides of the pixel region as an axis of symmetry. A position of a tip end of the drain lead-out wiring 16 is not especially limited, but preferably overlaps the trunk portion 22a of the common electrode 22.

The comb teeth 16b of the drain lead-out wiring 16 respectively overlap the comb teeth 22b of the common electrode 22 via an insulating film. The signal voltage is applied to the comb teeth 16b of the drain lead-out wiring 16, and therefore a region having tightly packed equipotential lines, formed in the liquid crystal layer, can be concentrated within a narrow range, enabling a reduction in the range of the region having tightly packed equipotential lines.

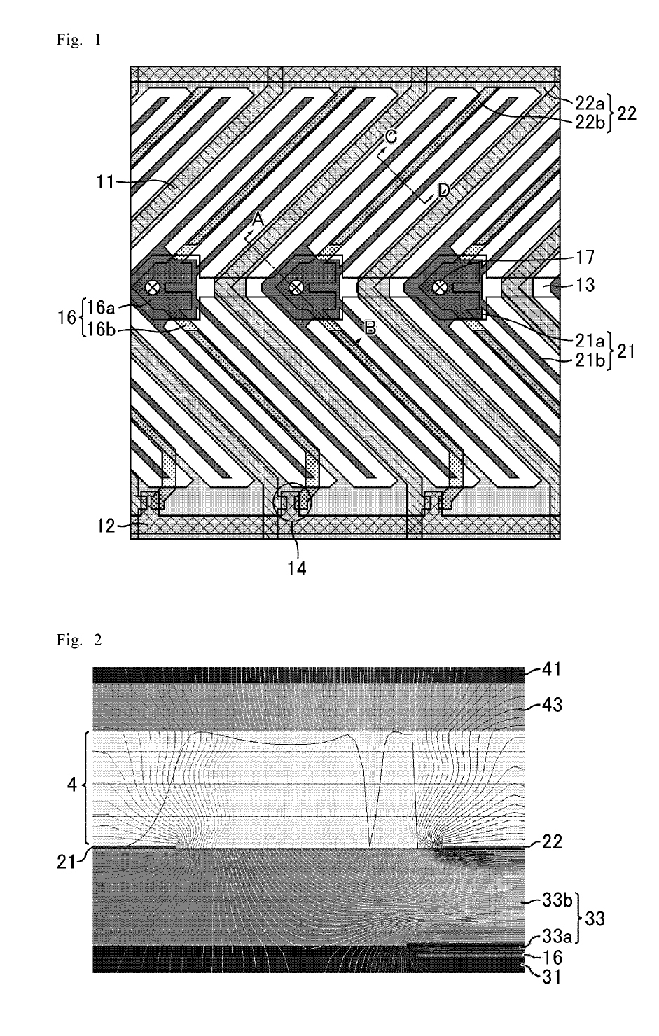

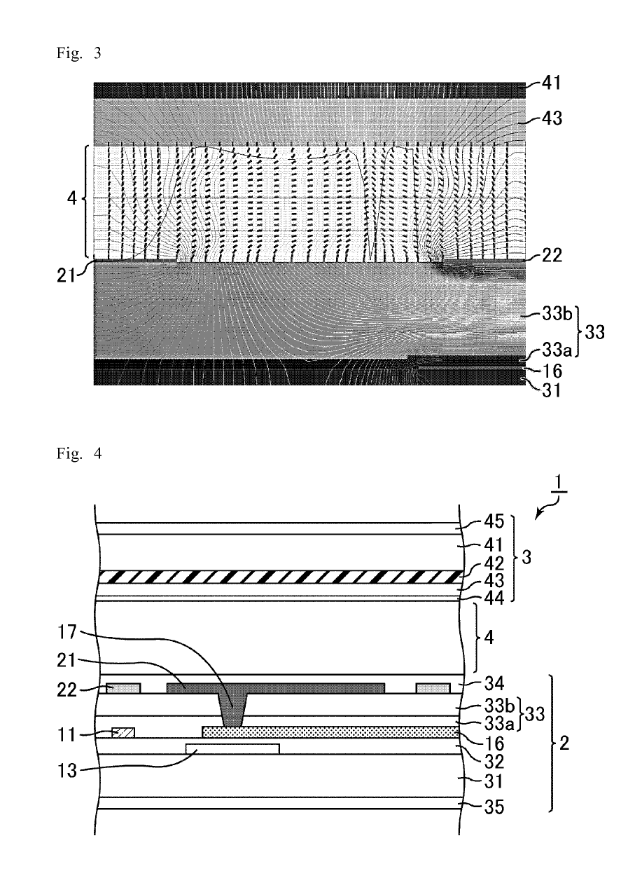

FIGS. 2 and 3 are sectional schematic views showing an electric field generated in the liquid crystal layer of the liquid crystal display device according to the first embodiment. FIG. 2 is a sectional schematic view showing equipotential lines and a transmitted light intensity in addition to the device configuration, and FIG. 3 is a sectional schematic view additionally showing the alignment condition of the liquid crystal molecules.

As shown in FIGS. 2 and 3, in the liquid crystal layer 4 of the liquid crystal display device according to the first embodiment, an electric field depicting an arch shape is generated roughly between the pair of electrodes constituted by the pixel electrode 21 and the common electrode 22, and the region having tightly packed equipotential lines is generated in a concentrated region in a region of the liquid crystal layer 4 between the pair of electrodes 21, 22 but closer to the common electrode 22 and the drain lead-out wiring 16. In the region having tightly packed equipotential lines, the alignment of the liquid crystal molecules is disturbed, leading to a reduction in transmittance. In comparison with the liquid crystal display device according to Reference Example 1, shown in FIGS. 14 and 15, however, the range of this region is narrow, and therefore the transmittance is greatly improved.

By providing the wiring to which the signal voltage is applied on a lower layer of the common electrode 22 via the interlayer dielectric 33 in this manner, evenness in a balance of the electric field formed by the pair of electrodes 21, 22 in the liquid crystal layer 4 can be eliminated, and therefore the region having tightly packed equipotential lines can be narrowed. As a result, an overall improvement in transmittance can be achieved. Here, a multilayer film constituted by the inorganic insulating film 33a and the organic insulating film 33b is used as the interlayer dielectric 33. In the first embodiment, the drain lead-out wiring 16 for supplying the signal voltage to the pixel electrode 21 is used as a supplementary electrode. The drain lead-out wiring 16 is disposed to overlap the comb teeth of the common electrode 22, and by applying the signal voltage to the drain lead-out wiring 16, evenness in the balance of the electric field can be eliminated effectively.

As shown in FIG. 1, in the first embodiment in particular, the comb teeth 16b of the drain lead-out wiring 16 extend from the trunk portion 16a so as to overlap not only the comb tooth 22b of the common electrode 22 that overlaps the gate bus line 12 corresponding to a lower side of the pixel region, but also the comb tooth 22b of the common electrode 22 that overlaps the gate bus line 12 corresponding to an upper side of the pixel region. As a result, greater transmittance can be obtained than in a case where only the drain lead-out wiring 16 extending from the TFT 14 to the contact portion 17 is caused to overlap the comb teeth 22b of the common electrode 22.

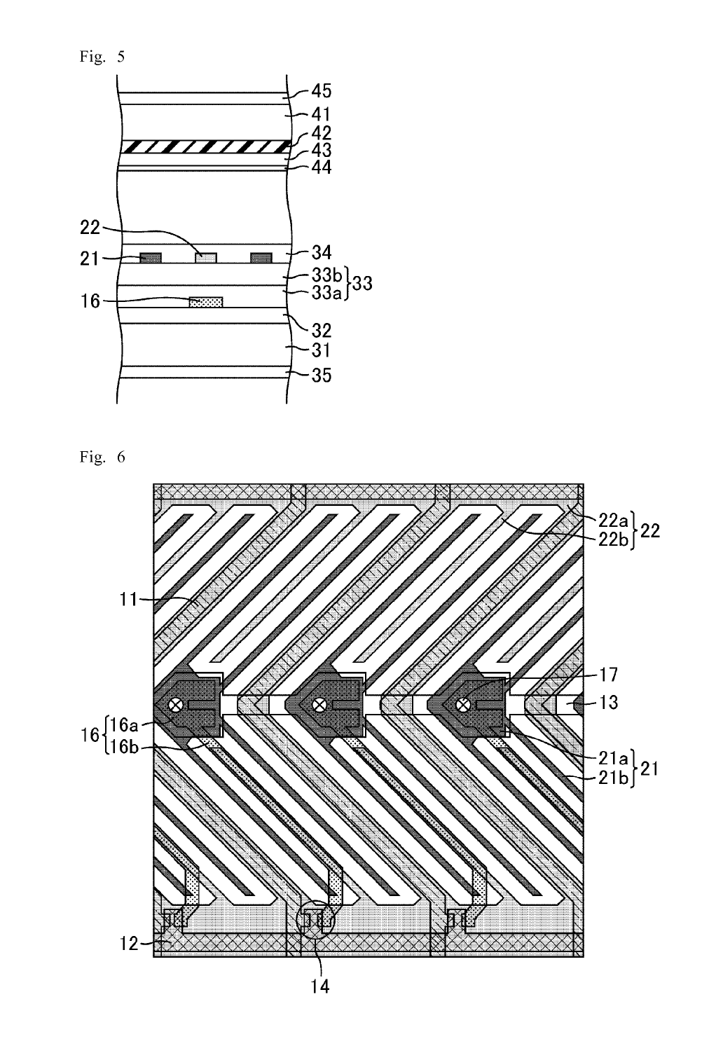

FIGS. 4 and 5 are sectional schematic views showing the liquid crystal display device according to the first embodiment.

FIG. 4 is a sectional schematic view taken along an A-B line in FIG. 1, and FIG. 5 is a sectional schematic view taken along a C-D line in FIG. 1. The liquid crystal display device according to the first embodiment includes a liquid crystal display panel 1, and a backlight unit (not shown) provided on a back surface side of the liquid crystal display panel. As shown in FIGS. 4 and 5, the liquid crystal display panel 1 includes a TFT substrate (a first substrate) 2, an opposed substrate (a second substrate) 3 disposed opposite the TFT substrate 2, and the liquid crystal layer 4 interposed between the TFT substrate 2 and the opposed substrate 3.

As shown in FIG. 4, the TFT substrate 2 includes the Cs bus line 13, which is formed on a liquid crystal layer 4 side surface of an insulating substrate 31, and the source bus line 11 and drain lead-out wiring 16, which are formed thereon via a gate insulator 32. The gate bus line is disposed on an identical layer to a layer formed with the Cs bus line 13. Further, the source bus line 11 is disposed on an identical layer to a layer formed with the drain lead-out wiring 16. Note that the gate bus line and the Cs bus line 13 may be formed on a layer further toward the liquid crystal layer 4 side than the layer formed with the source bus line 11 and the drain lead-out wiring 16.

A light transmissive material such as glass or plastic may be used as a material of the insulating substrate 31. A transparent insulating material such as silicon oxide or silicon nitride may be used as a material of the gate insulator 32.

A metal such as aluminum, tantalum, or molybdenum may be used as a material of the gate bus line, the source bus line 11, the Cs bus line 13, and the drain lead-out wiring 16. Since the gate bus line and the Cs bus line 13 are disposed on the same layer, a manufacturing process can be simplified by using an identical material for these components. Further, since the source bus line 11 and the drain lead-out wiring 16 are disposed on the same layer, a manufacturing process can be simplified by using an identical material for these components.

The interlayer dielectric 33 is formed on a liquid crystal layer 4 side surface of the source bus line 11 and drain lead-out wiring 16. The drain lead-out wiring 16 and the pixel electrode 21 are connected via the contact portion 17 provided in the interlayer dielectric 33. Further, the drain lead-out wiring 16 is disposed to overlap the Cs bus line 13 via the gate insulator 32. Thus, a certain amount of storage capacitance can be formed, thereby preventing a image signal from leaking and becoming extinct.

As shown in FIG. 5, in the first embodiment, the drain lead-out wiring 16 to which the signal voltage is applied overlaps the common electrode 22 via the interlayer dielectric 33. This affects the electric field formed between the pixel electrode 21 and the common electrode 22 such that the range of the region having tightly packed equipotential lines can be reduced. As a result, an improvement in transmittance is achieved.

The pixel electrode 21 and the common electrode 22 are disposed on an identical layer. More specifically, the pixel electrode 21 and the common electrode 22 are disposed on the liquid crystal layer 4 side of the gate bus line and the source bus line 11. Hence, a transverse electric field can be formed between the pixel electrode 21 and the common electrode 22 at a high density, enabling highly precise control of the alignment of the liquid crystal molecules in the liquid crystal layer 4. As a result, high transmittance can be realized.

A metal oxide such as indium tin oxide (ITO) or indium zinc oxide (IZO), a metal such as aluminum or chrome, and so on may be used as a material of the pixel electrode 21 and the common electrode 22. Since the pixel electrode 21 and the common electrode 22 are disposed on the same layer, a manufacturing process can be simplified by using an identical material for these components.

A material of the interlayer dielectric 33 may be inorganic or organic. Further, the interlayer dielectric 33 may be formed from a plurality of layers constituted by different materials, and the plurality of layers may have a stacked structure constituted by an inorganic insulating layer and an organic insulating layer. An overall thickness of the interlayer dielectric 33 is preferably between 2 and 5 μm, and more preferably between 3.5 and 4.5 μm. When the thickness is smaller than 2 μm, a capacitance component may increase. When the thickness exceeds 5 μm, on the other hand, the reduction in transmittance may increase.

In FIGS. 4 and 5, the interlayer dielectric 33 has a stacked structure constituted by the inorganic insulating film 33a and the organic insulating film 33b. Transparent silicon oxide, silicon nitride (dielectric constant=8), and so on may be used as a material of the inorganic insulating film 33a. Transparent, light-sensitive acrylic resin (dielectric constant=2.7 to 4.5), for example JAS-150 manufactured by JSR Corporation (dielectric constant=3.4), may be used as a material of the organic insulating film 33b.

A vertical alignment film 34 is disposed on the liquid crystal layer 4 side surface of the pixel electrode 21 and the common electrode 22 so as to cover the electrodes. An initial tilt of the liquid crystal molecules can be aligned so as to be orthogonal (90°±4°) to the TFT substrate 10 surface by the vertical alignment film 34, whereby a TBA alignment can be obtained. A resin such as polyimide may be used as a material of the vertical alignment film 34.

The opposed substrate 3 disposed opposite the TFT substrate 2 via the liquid crystal layer 4 includes an organic resin layer 42, which is provided on a liquid crystal layer 4 side surface of a colorless, transparent insulating substrate 41 and includes a color filter (CF) layer provided such that a range thereof overlaps the respective pixel regions and a black matrix (BM) layer that blocks light between the respective CFs, and also includes an overcoat (OC) layer 43 provided on the liquid crystal layer 4 side of the organic resin layer 42 to smooth irregularities on a surface of the organic resin layer 42. By providing the OC layer 43, irregularities on the surface of the organic resin layer 42 are eliminated, and therefore a situation in which driving voltage becomes uneven over a single pixel region, leading to a reduction in contrast, can be prevented. A vertical alignment film 44 similar to that of the TFT substrate 2 is disposed on a liquid crystal layer 4 side surface of the OC layer 43.

The BM layer is formed to overlap a periphery of the pixel region, or in other words to overlap the source bus line 11 and the gate bus line 12. The CF layer is used to perform color display, and is formed from a pigmented transparent organic resin such as acrylic resin so as to overlap the pixel region, or in other words to overlap a region surrounded by the source bus line 11 and the gate bus line 12.

A light transmissive insulating material such as glass or plastic may be used as a material of the insulating substrate 41. A metal having a light blocking property such as Cr, an organic film having a light blocking property made of acrylic resin containing carbon or the like, and so on may be used as a material of the BM layer. Acrylic resin containing carbon or the like (dielectric constant=2.7 to 4.5) may be used as a material of the OC layer, and a thickness of the OC layer is preferably between 1 and 3 μm.

Hence, the liquid crystal display device according to the first embodiment is a color liquid crystal display device having a color layer on the opposed substrate 3, in which a single picture element is constituted by three pixels that respectively output light in colors such as R (red), G (green), and B (Blue). In the first embodiment, the color types and the number of colors of the pixels constituting each picture element are not especially limited and may be set appropriately. For example, each picture element may be constituted by pixels in the three colors—cyan, magenta, and yellow, or by pixels in four or more colors. Note that the liquid crystal display device according to the first embodiment may perform monochrome display such that the color filters are not required.

The TFT substrate 2 and the opposed substrate 3 are adhered to each other using a sealing agent applied to an outer periphery of a display area via a spacer made of plastic beads or the like. The liquid crystal layer 4 is formed by sealing a liquid crystal material serving as a display medium that constitutes an optical modulation layer into a gap between the TFT substrate 2 and the opposed substrate 3.

In the first embodiment, the liquid crystal layer 4 contains a nematic liquid crystal material (a p-type nematic liquid crystal material) having positive dielectric anisotropy. The dielectric anisotropy (Δ∈) of the p-type nematic liquid crystal material is preferably between 10 and 25. Further, a thickness of the liquid crystal layer 4 is preferably between 3 and 5 μm. When the thickness is smaller than 3 μm, it may be impossible to obtain sufficient retardation, and therefore the transmittance may decrease. When the thickness exceeds 5 μm, a white tinge may form on an image.

A polarizer 35 is adhered to a surface of the insulating substrate 31 of the TFT substrate 2 on an opposite side to the liquid crystal layer 4. A polarizer 45 is adhered to a surface of the insulating substrate 41 of the opposed substrate 3 on an opposite side to the liquid crystal layer 4. Respective transmission axes of the polarizers 35, 45 have a cross nicol relationship so as to intersect each other orthogonally. Further, the transmission axis of the TFT substrate 2 side polarizer 35 and the transmission axis of the opposed substrate 3 side polarizer 45 are both disposed to form an angle of 45° with respective extension directions of the comb teeth 21b of the pixel electrode 21 and the comb teeth 22b of the common electrode 22. Note that in the first embodiment, a phase difference plate and a viewing angle compensation film may be disposed in addition to the polarizers 35, 45.

### Second Embodiment

A liquid crystal display device according to the second embodiment differs from the first embodiment in that the comb teeth of the drain lead-out wiring overlap only the comb tooth of the common electrode that extends from the trunk portion of the common electrode corresponding to the lower side of the pixel region, and does not overlap the comb tooth of the common electrode that extends from the trunk portion of the common electrode corresponding to the upper side of the pixel region, but is otherwise similar to the first embodiment. FIG. 6 is an enlarged planar schematic view showing a display region of the liquid crystal display device according to the second embodiment. Note that likewise in the second embodiment, the drain lead-out wiring 16 constitutes the extension wiring of the present invention.

As shown in FIG. 6, in the second embodiment, the drain lead-out wiring 16 is configured to include the trunk portion 16a and the comb teeth 16b. The comb teeth 16b of the drain lead-out wiring 16 are formed in the gaps between the comb teeth 21b of the pixel electrode 21 via an insulating film such that the comb teeth 21b of the pixel electrode 21 and the comb teeth 16b of the drain lead-out wiring 16 have a mutually parallel relationship.

Even when the comb teeth 16b overlap only the comb tooth 22b of the common electrode 22 that extends from the trunk portion 22a of the common electrode 22 corresponding to the lower side of the pixel region in this manner, a wiring to which the signal voltage can be applied is provided on the lower layer of the common electrode 22 via an insulating film, and therefore evenness in the balance of the electric field formed by the pair of electrodes in the liquid crystal layer can be eliminated in the region where the comb tooth 22b of the common electrode 22 and the comb tooth 16b of the drain lead-out wiring 16 overlap. As a result, the region having tightly packed equipotential lines can be narrowed, enabling an overall improvement in transmittance. Note that likewise in the second embodiment, the drain lead-out wiring 16 for supplying the signal voltage to the pixel electrode 21 is used as a supplementary electrode, and by applying the signal voltage to the drain lead-out wiring 16, evenness in the balance of the electric field can be eliminated effectively.

### Third Embodiment

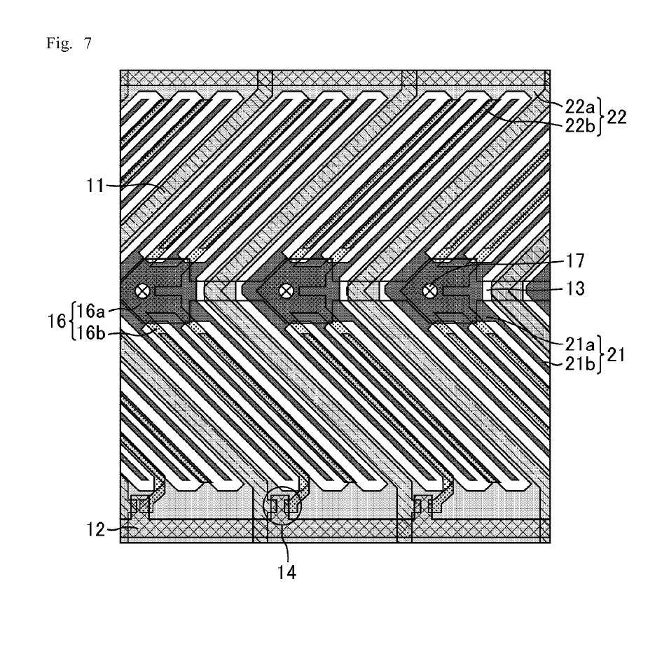

A liquid crystal display device according to a third embodiment differs from the first embodiment in that both the pixel electrode and the common electrode are provided with a plurality of comb teeth, but is otherwise similar to the first embodiment. FIG. 7 is an enlarged planar schematic view showing a display region of the liquid crystal display device according to the third embodiment. Note that likewise in the third embodiment, the drain lead-out wiring 16 constitutes the extension wiring of the present invention.

As shown in FIG. 7, in the third embodiment, both the comb teeth 21b of the pixel electrode 21 and the comb teeth 22b of the common electrode 22 are provided in a plurality within a single pixel region, and the comb teeth 16b of the drain lead-out wiring 16 are disposed to overlap all of the comb teeth 22b of the common electrode 22. Hence, in comparison with a case where the comb teeth of the drain electrode are disposed to overlap a part of the comb teeth of the common electrode, the range of the region having tightly packed equipotential lines in the pixel region can be reduced even further, enabling a great improvement in transmittance.

In the third embodiment, similarly to the first embodiment, the comb teeth 16b of the drain lead-out wiring 16 are formed in the gaps between the comb teeth 21b of the pixel electrode 21 via an insulating film such that the comb teeth 21b of the pixel electrode 21 and the comb teeth 16b of the drain lead-out wiring 16 have a mutually parallel relationship. Further, the drain lead-out wiring 16 has a vertically symmetrical pattern about a bisector dividing the longitudinal sides of the pixel region as an axis of symmetry.

In FIG. 7, each pixel electrode 21 is formed with three comb teeth 21b extending toward the trunk portion 22a of the common electrode 22 that corresponds to the side located upward from the bisector vertically to the longitudinal direction of the pixel region and three comb teeth 21b extending toward the trunk portion 22a of the common electrode 22 that corresponds to the side located downward from the bisector vertically to the longitudinal direction of the pixel region. Further, each common electrode 22 is formed with two comb teeth 22b extending toward the trunk portion 21a of the pixel electrode 21 on the bisector vertically to the longitudinal direction of the pixel region and two comb teeth 22b extending toward the trunk portion 21a of the pixel electrode 21 on the bisector vertically to the longitudinal direction of the pixel region. However, the number of comb teeth 21b provided on the pixel electrode 21 and the number of comb teeth 22b provided on the common electrode 22 in the third embodiment are not especially limited. Further, the number of comb teeth 16b provided on the drain lead-out wiring 16 is not especially limited.

In a modified example of the third embodiment, the comb teeth of the drain electrode may be configured to overlap only the comb tooth of the common electrode extending from the trunk portion corresponding to the lower side of the pixel region and not to overlap the comb tooth of the common electrode extending from the trunk portion corresponding to the upper side of the pixel region, as in the second embodiment.

### Fourth Embodiment

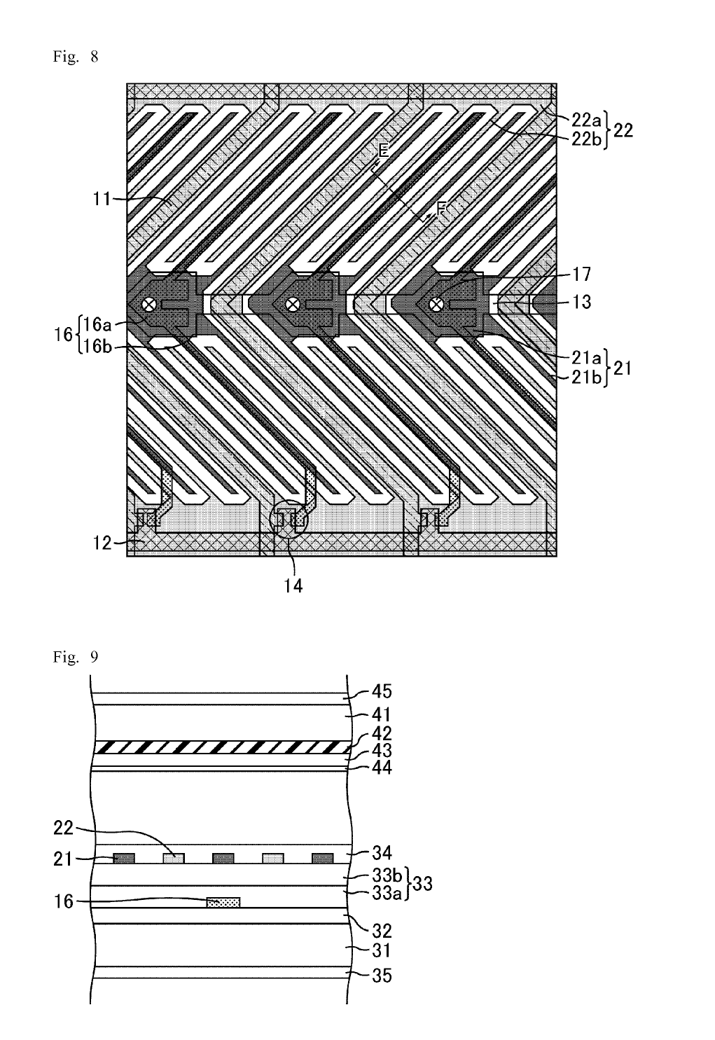

A liquid crystal display device according to the fourth embodiment differs from the first embodiment in that the comb teeth of the drain lead-out wiring overlap the comb teeth of the pixel electrode rather than the comb teeth of the common electrode and that both the pixel electrode and the common electrode are formed with a plurality of comb teeth, but is otherwise similar to the first embodiment. FIG. 8 is an enlarged planar schematic view showing a display region of the liquid crystal display device according to the fourth embodiment. Note that likewise in the fourth embodiment, the drain lead-out wiring 16 constitutes the extension wiring of the present invention.

As shown in FIG. 8, in the fourth embodiment, the drain lead-out wiring 16 is configured to include the trunk portion 16a and the comb teeth 16b, and the comb teeth 16b of the drain lead-out wiring 16 overlap the comb teeth 21b of the pixel electrode 21 via an insulating film. Further, the comb teeth 16b of the drain lead-out wiring 16 are formed in the gaps between the comb teeth 22b of the common electrode 22 such that the comb teeth 22b of the common electrode 22 and the comb teeth 16b of the drain lead-out wiring 16 have a mutually parallel relationship. Furthermore, the drain lead-out wiring 16 has a vertically symmetrical pattern about a bisector dividing the longitudinal sides of the pixel region as the axis of symmetry.

FIG. 9 is a sectional schematic view taken along an E-F line in FIG. 8. As shown in FIG. 9, in the fourth embodiment, the drain lead-out wiring 16 to which the signal voltage is applied overlaps the pixel electrode 21 via the interlayer dielectric 33 (the multilayer film constituted by the inorganic insulating film 33a and the organic insulating film 33b). This affects the electric field formed between the pixel electrode 21 and the common electrode 22 such that the region having tightly packed equipotential lines can be concentrated. As a result, the region having tightly packed equipotential lines can be narrowed, leading to an improvement in transmittance.

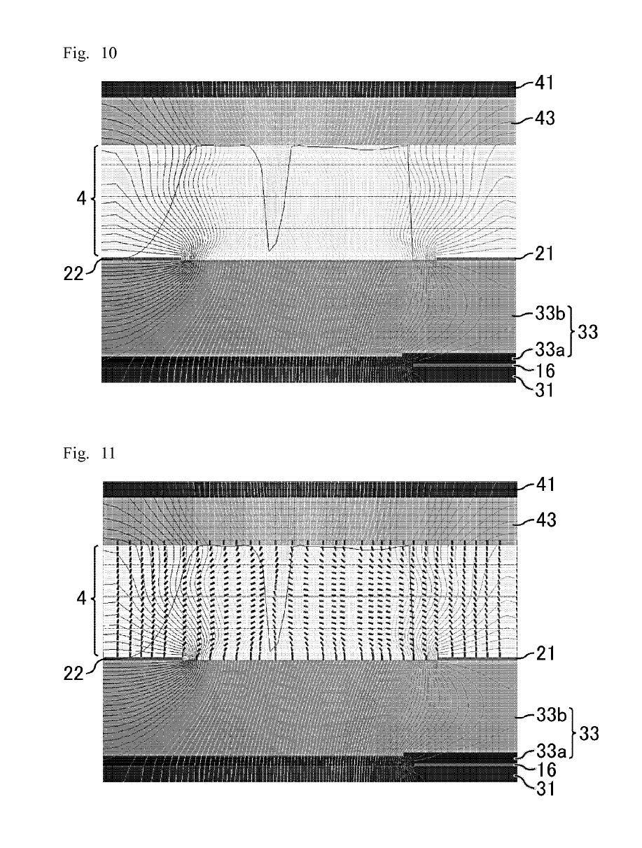

FIGS. 10 and 11 are sectional schematic views showing the electric field generated in the liquid crystal layer of the liquid crystal display device according to the fourth embodiment. FIG. 10 is a schematic view showing equipotential lines and a transmitted light intensity in addition to the device configuration, and FIG. 11 is a schematic view additionally showing the alignment condition of the liquid crystal molecules.

As shown in FIGS. 10 and 11, in the liquid crystal layer of the liquid crystal display device according to the fourth embodiment, an electric field depicting an arch shape is generated roughly between the pair of electrodes constituted by the pixel electrode 21 and the common electrode 22, and the region having tightly packed equipotential lines is generated in a concentrated region in a region of the liquid crystal layer 4 between the pair of electrodes but closer to the common electrode 22. In the region having tightly packed equipotential lines, the alignment of the liquid crystal molecules is disturbed, leading to a reduction in transmittance. In comparison with the liquid crystal display device according to Reference Example 1, shown in FIGS. 14 and 15, however, the range of this region is narrow, and therefore the transmittance is greatly improved.

By providing the wiring to which the signal voltage is applied on the lower layer of the pixel electrode 21 via an insulating film in this manner, evenness in the balance of the electric field formed by the pair of electrodes in the liquid crystal layer 4 can be eliminated, and therefore the region having tightly packed equipotential lines can be narrowed. As a result, an overall improvement in transmittance can be achieved. Further, as shown in FIG. 8, in the fourth embodiment, the drain lead-out wiring 16 for supplying the signal voltage to the pixel electrode 21 is used as a supplementary electrode and disposed along the comb teeth 21b of the pixel electrode 21. Hence, by applying the signal voltage to the drain lead-out wiring 16, evenness in the balance of the electric field can be eliminated effectively.

In the fourth embodiment in particular, the comb teeth 16b of the drain lead-out wiring 16 extend from the trunk portion 16a so as to overlap not only the comb teeth 21b of the pixel electrode 21 that extend toward the trunk portion 22a of the common electrode 22 corresponding to the lower side of the pixel region, but also the comb teeth 21b of the pixel electrode 21 that extend toward the trunk portion 22a of the common electrode 22 corresponding to the upper side of the pixel region. Therefore, greater transmittance can be obtained than in a case where only the drain lead-out wiring 16 extending from the TFT 14 to the contact portion 17 is caused to overlap the comb teeth 21b of the pixel electrode 21. Note that the position of the tip end of the drain lead-out wiring 16 is not especially limited, but preferably overlaps the trunk portion 22a of the common electrode 22 or the tip end of the comb tooth 16a of the pixel electrode 16. The tip end of the drain lead-out wiring 16 preferably does not overlap the gate bus line 12.

In a first modified example of the fourth embodiment, at least one of the pixel electrode and the common electrode has a single comb tooth.

In a second modified example of the fourth embodiment, the comb teeth 16b of the drain lead-out wiring 16 overlap only the comb teeth 21b of the pixel electrode 21 that extend toward the trunk portion 22a of the common electrode 22 corresponding to the lower side of the pixel region, from among the comb teeth of the pixel electrode.

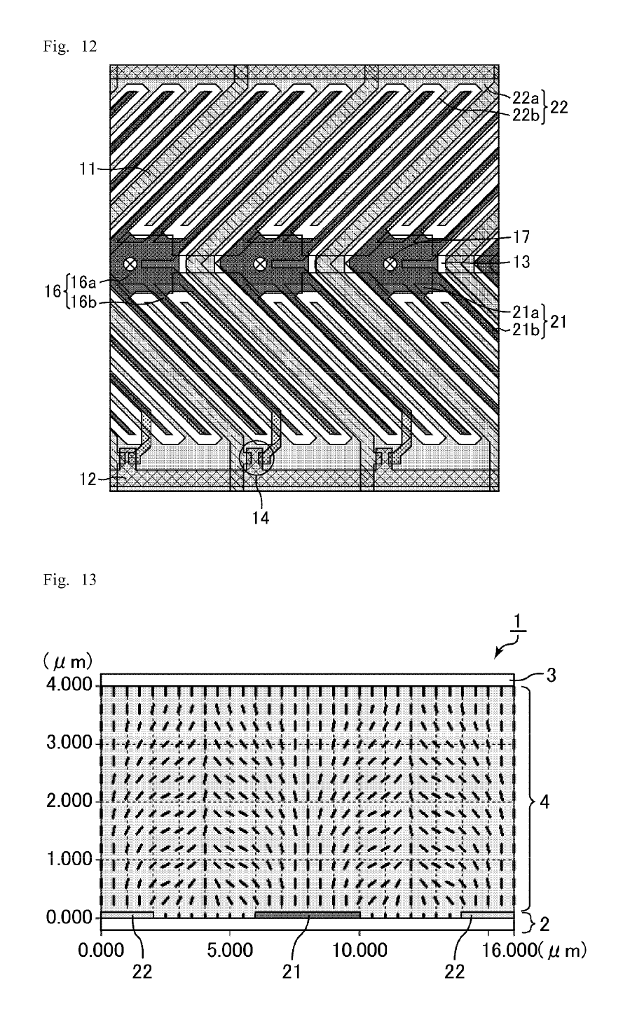

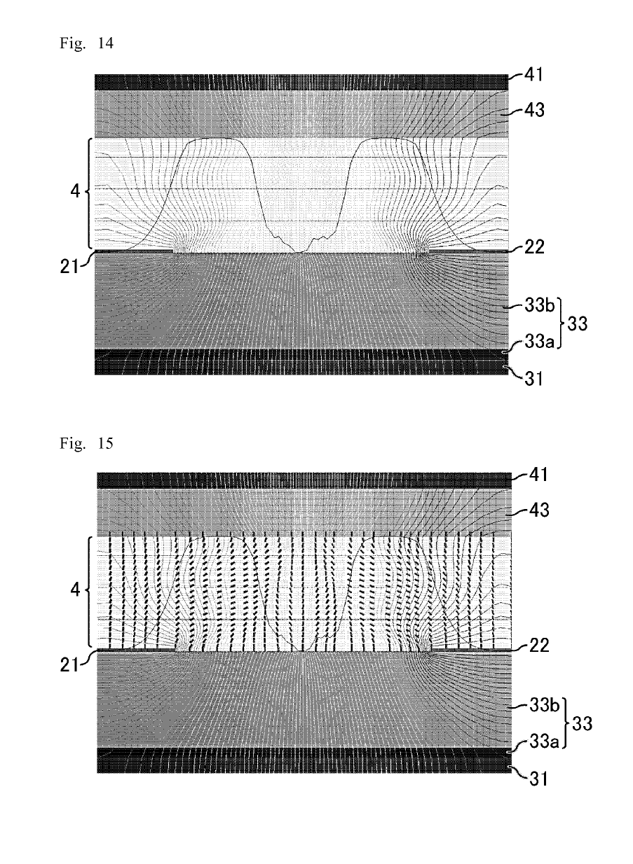

In a third modified example of the fourth embodiment, as shown in FIG. 12, the comb teeth of the drain lead-out wiring are formed along all of the plurality of comb teeth of the pixel electrode so as to overlap the comb teeth. As a result, a further improvement in transmittance can be achieved.

### Fifth Embodiment

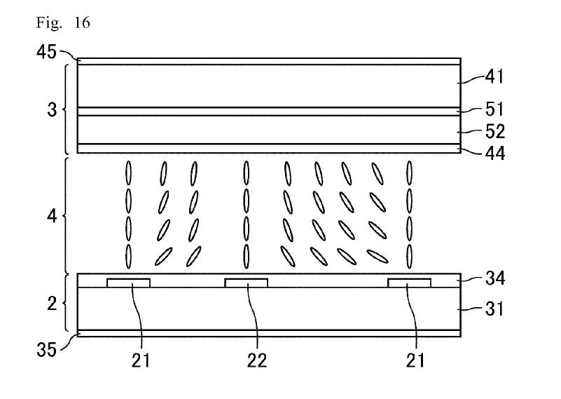

A liquid crystal display device according to a fifth embodiment differs from the first to fourth embodiments in that a common electrode is provided on the opposed substrate side, but is otherwise similar to the first to fourth embodiments. FIG. 16 is a sectional schematic view showing the configuration of the liquid crystal display device according to the fifth embodiment. More specifically, as shown in FIG. 16, the opposed substrate 3 includes the insulating substrate 41, and a common electrode 51, a dielectric layer (an insulating layer) 52, and a vertical alignment layer 44 are stacked in that order on a liquid crystal layer 4 side main surface of the insulating substrate 41. Note that an organic resin layer may be provided between the common electrode 51 and the insulating substrate 41.

The common electrode 51 is formed from a transparent conductive film made of ITO, IZO, or the like. The common electrode 51 and the dielectric layer 52 are respectively formed without seams so as to cover at least an entire display area. A certain potential common to all of the pixels is applied to the common electrode 51.

The dielectric layer 52 is formed from a transparent insulating material. More specifically, the dielectric layer 52 is formed from an inorganic insulating film made of silicon nitride or the like, an organic insulating film made of acrylic resin or the like, and so on.

The TFT substrate 2 includes the insulating substrate 31, and the TFT substrate 2 is provided with the pixel electrode 21 and the common electrode 22, which are similar to those of the first to fourth embodiments, and the vertical alignment film 34. Further, the polarizers 35, 45 are disposed on respective outer main surfaces of the TFT substrate 2 and the opposed substrate 3.

Apart from during black display, the voltage applied to the pixel electrode 21 is different from the voltages applied to the common electrode 22 and opposed electrode 51. The common electrode 22 and opposed electrode 51 may be grounded. Alternatively, voltages having identical magnitudes and polarities or voltages having different magnitudes and polarities may be applied to the common electrode 22 and the opposed electrode 51.

Likewise with the liquid crystal display device according to this embodiment, similarly to the first embodiment, an improvement in transmittance can be achieved. Further, by forming the common electrode 51, an improvement in response time can be achieved.

The present application clams priority to Patent Application No. 2009-158673 filed in Japan on Jul. 3, 2009 and Patent Application No. 2010-006695 filed in Japan on Jan. 15, 2010 under the Paris Convention and provisions of national law in a designated state, the entire contents of which are hereby incorporated by reference.

### EXPLANATION OF REFERENCE NUMERALS

1 liquid crystal display panel
2 TFT substrate
3 opposed substrate
4 liquid crystal layer
11 source bus line
12 gate bus line
13 Cs bus line
14 thin film transistor (TFT)
16 drain lead-out wiring
16a drain lead-out wiring (trunk portion)
16b drain lead-out wiring (comb tooth)
17 contact portion
21 pixel electrode
21a pixel electrode (trunk portion)
21b pixel electrode (comb tooth)
22 common electrode
22a common electrode (trunk portion)
22b common electrode (comb tooth)
31 insulating substrate
32 gate insulator
33 interlayer dielectric
33a inorganic insulating film
33b organic insulating film
34, 44 vertical alignment film
35, 45 polarizer
41 insulating substrate
43 organic resin layer
43 overcoat (OC) layer
51 common electrode
52 dielectric layer (insulating layer)

1. A liquid crystal display device comprising a first substrate and a second substrate disposed to face each other, and a liquid crystal layer interposed between the first substrate and the second substrate, wherein:
the first substrate includes a pixel electrode to which a signal voltage is supplied and a common electrode to which a common voltage is supplied;
the pixel electrode and the common electrode both comprise comb teeth;
the comb teeth of the pixel electrode and the comb teeth of the common electrode are disposed with each other alternately via an interval;
the liquid crystal layer contains liquid crystal molecules having positive dielectric anisotropy;
the liquid crystal molecules are aligned in a direction orthogonal to a surface of the first substrate in a voltage non-application condition;
the first substrate includes an extension wiring provided in a position overlapping at least one comb tooth of the comb teeth of the pixel electrode and the common electrode so as to extend along the at least one comb tooth via an insulating film; and
the extension wiring serves as a wiring to which the signal voltage is supplied.

2. The liquid crystal display device according to claim 1, wherein the pixel electrode is connected to a drain electrode of a thin film transistor via a contact portion and the extension wiring.

3. The liquid crystal display device according to claim 1, wherein the extension wiring overlaps the comb teeth of the common electrode via the insulating film.

4. The liquid crystal display device according to claim 1, wherein the extension wiring overlaps the comb teeth of the pixel electrode via the insulating film.

5. The liquid crystal display device according to claim 1, wherein the extension wiring includes a trunk portion and a plurality of comb teeth extending from the trunk portion.

6. The liquid crystal display device according to claim 1, wherein the pixel electrode includes a trunk portion and a plurality of comb teeth extending from the trunk portion.

7. The liquid crystal display device according to claim 1, wherein the common electrode is disposed on a periphery of the pixel electrode.

8. The liquid crystal display device according to claim 1, wherein a width of the extension wiring is smaller than a width of the at least one comb tooth overlapped by the extension wiring.
